(19) United States
(12) Patent Application Publication
(10) Pub. No.: US 2009/0104485 A1
(43) Pub. Date: Apr. 23, 2009

(54) AUXILIARY POWER UNIT FOR GENERATING ELECTRICAL POWER

(75) Inventors: Peter James Schubert, Naperville, IL (US); John Carl Christenson, Kokomo, IN (US); Dan W. Chilcott, Greentown, IN (US)

Correspondence Address: HARTMAN & HARTMAN, P.C., 552 EAST 700 NORTH, VALPARAISO, IN, 46383, US

(73) Assignee: PACKER ENGINEERING, INC., Naperville, IL (US)

(21) Appl. No.: 12/103,988

(22) Filed: Apr. 16, 2008

Related U.S. Application Data
(62) Division of application No. 10/824,719, filed on Apr. 15, 2004.
(60) Provisional application No. 60/474,721, filed on May 30, 2003.
(60) Provisional application No. 60/477,156, filed on Jun. 9, 2003.

(51) Int. Cl. H01M 8/04

(52) U.S. Cl. 429/19

(57) ABSTRACT

An auxiliary power unit for generating electrical power. The auxiliary power unit includes a fuel cell system for combining hydrogen and oxygen to provide electrical power, and a system for storing and retrieving elemental hydrogen for supplying hydrogen to the fuel cell system. The storing and retrieving system contains at least one hydrogen storage member formed by a mass of porous silicon having interior and exterior surfaces, in which at least the interior surfaces have dangling bond sites at which reversible chemisorption of hydrogen atoms occurs. The storing and retrieving system further includes a control system for liberating the chemisorbed hydrogen atoms from the dangling bond sites and releasing the liberated hydrogen atoms as hydrogen gas for use by the fuel cell system.

### CROSS REFERENCE TO RELATED APPLICATIONS

This is a division patent application of co-pending U.S. patent application Ser. No. 10/824,719, filed Apr. 15, 2004, and claims priority from U.S. Provisional Patent Application Ser. No. 60/474,721, filed May 30, 2003 and U.S. Provisional Patent Application Ser. No. 60/477,156, filed Jun. 9, 2003. The contents of these prior applications are incorporated herein by reference.

### BACKGROUND OF THE INVENTION

The present invention relates to means for storing hydrogen; more particularly, to means for adsorptively storing hydrogen on crystalline substrates; and most particularly, to method and apparatus for storing elemental hydrogen on elemental silicon substrates.

In the State of the Union address in January, 2003, President George W. Bush announced a hydrogen fuel initiative aimed at reversing America's growing dependence on foreign oil by developing hydrogen-based fuel cell technology, the ultimate goal being commercially viable hydrogen-powered fuel cells capable of powering cars, trucks, homes, and businesses. Thus, development of hydrogen-based fuel cells has been identified as a priority for the United States.

One of the many reasons hydrogen-based fuel cells are desirable is that they are readily adaptable to use as energy sources in numerous and diverse applications, from cellular phones to space ships. Another desirable attribute of purely hydrogen-based fuel cells is that their only byproduct is water vapor, and they are therefore benign environmentally. Thus, hydrogen fuel cells represent a potentially important source of energy for a wide range of applications.

Efficient storage of hydrogen is vitally important for cost-effective system implementation. When compared with storage for conventional chemical fuels or electric energy sources, prior art hydrogen storage lacks the convenience of gasoline for delivery and storage capacity (energy density per unit weight), and lacks the flexibility of electrical energy stored in batteries or capacitors. Therefore, for fuel cells to reach their full commercial potential, an improved means for hydrogen storage is needed.

Prior art methods of storing hydrogen fall broadly into two categories.

The first category involves storing hydrogen chemically within a convenient chemical molecule, usually an aliphatic organic compound such as methane, octane, etc., and then pre-processing the fuel as needed, as by catalytic reforming, to release elemental hydrogen plus carbon oxides. This method suffers two important drawbacks: a) carbon dioxide byproduct is a “greenhouse gas” that some believe contributes to global warming and thus is considered environmentally undesirable; and b) the additional weight of the chemical molecule and the reformer reduce the efficiency of the entire process and make it less attractive from a cost and performance standpoint.

The second category involves mechanical or adsorptive storage of elemental hydrogen in one of three forms: compressed gas, cryogenically-refrigerated liquid, or chemisorbed onto active surfaces.

Of these methods, compressed gas storage is the most straightforward and is a mature technology. However, compressed gas cylinders are quite heavy, needing sufficient strength to withstand pressures of many hundreds of pounds per square inch. This weight is a considerable drawback for portable applications, and in any usage compressed gas cylinders must be treated with care, as they represent a safety hazard.

Cryogenic storage of hydrogen is also well known, being used in industrial plants and as a rocket fuel. Liquid hydrogen is remarkably dense from a specific energy point of view (kilowatts per kilogram) but requires a considerable amount of additional energy to maintain the nearly absolute zero temperatures needed to keep hydrogen in a liquid state. Liquid hydrogen also requires a heavy mass of insulation, and these factors conspire to make cryogenic storage impractical for portable and small-scale applications.

The present invention is directed to chemisorption of hydrogen onto active surfaces as a means of storage. chemisorption as used herein means the adsorption of a given molecule onto an active surface, typically of a solid or a solid matrix. chemisorption is typically reversible, although the energy of adsorption and the energy of desorption are usually different. Various catalysts and surface preparations are possible, providing a wide range of possible chemistries and surface properties to a given storage problem. Chemisorption of hydrogen has been studied extensively. Substances such as metal hydrides, palladium, and carbon nanofibers are known to have been used to adsorb and desorb hydrogen.

Prior art hydrogen chemisorption falls short of the goals of efficiency, convenience, and low system cost, for several reasons. In some materials, such as carbon nanofibers, the efficiency of hydrogen adsorbed per unit weight of matrix is high, but the method of desorption requires high heat which brings about danger of combustion. Additionally, the present cost of carbon nanostructures is relatively high, and control over material properties can be quite difficult in high-volume manufacturing. In the case of metal halides, metal oxides, or other inorganic surfaces, efficiencies typically are lower and the adsorption/desorption process is highly dependent upon exacting chemistry. These factors combine to make such approaches less than sufficiently robust for many commercial applications.

Hydrogenated surfaces in silicon have also been employed, as disclosed in U.S. Pat. Nos. 5,604,162; 5,605,171; and 5,765,680, wherein the adsorbed molecule is the hydrogen isotope tritium. However, these attempts were intended only for storing that radioactive isotope in a manner that provided for safe transport of tritium, typically to a waste handling or storage facility, or as a means to provide radioactive energy to power a light source. In contrast to the present invention, prior art methods of chemisorption do not provide for desorption of hydrogen from the storage medium. In fact, conventional methods of chemisorption are generally designed to prevent desorption. Further, these conventional methods of chemisorption also fail to teach methods by which the storage capacity of a silicon matrix can be increased.

What is needed in the art is an improved means for storing elemental hydrogen.

### BRIEF SUMMARY OF THE INVENTION

It is a principal object of the present invention to provide low-cost, efficient, and safe storage of hydrogen.

The present invention provides a system for the storage and retrieval of elemental hydrogen and includes, in one form thereof, a plurality of types of hydrogen storage members comprising elemental silicon having at least one surface to which elemental hydrogen either readily bonds or is readily adsorbed, and from which desorption of elemental hydrogen may be controlled.

An advantage of the present invention is that the adsorption and desorption of elemental hydrogen may be tailored to suit the system to particular applications.

Another advantage of the present invention is that the elemental hydrogen remains safely adsorbed within the storage material in the event of catastrophic failure of the system.

A still further advantage of the present invention is the size, weight, and volume of a housing within which the elemental hydrogen is stored can also be adapted to application-specific requirements.

Briefly described, a system for adsorptively storing and desorptively recovering elemental hydrogen includes nano-scale finely-divided elemental silicon that has been prepared in any of several ways to present a very high silicon surface/weight ratio. Such preparation includes but is not limited to crushing, milling, etching, fiber extrusion, electrochemical etching, decoration etching, plasma reactive ion etching, electrochemical deposition, thin film vapor deposition, and immersion in a carrier gas or liquid. Silicon fibers may be formed from pure polysilicon as by centrifugal extrusion, and silicon particles may be, for example, recovered from process waste produced by the integrated circuit industry. There are several waste streams of silicon from the production of raw polysilicon to the crystal-growing process, to wafer finishing, and finally to wafer etching. An excellent example is the residual melt left over after Czochralski crystal pulling. Such material currently is disposed of or sold as low-value scrap to the makers of stainless steel. In the wafer sawing operation, both in wafer manufacture and in dicing of a fully-processed wafer, a great deal of finely-divided silicon is produced and then disposed of. Reclaiming this material directly is a very good source of silicon, although surface treatments will almost always be necessary to obtain a clean surface for hydrogen adsorption.

### BRIEF DESCRIPTION OF THE DRAWINGS

The present invention will now be described, by way of example, with reference to the accompanying drawings, in which:

FIG. 1 is a block diagram of an elemental hydrogen storage and retrieval system in accordance with the present invention as may be adapted for fueling a fuel cell system in a motor vehicle;

FIG. 2 is a schematic view of one embodiment of an elemental hydrogen storage and retrieval system in accordance with the present invention;

FIG. 3 is a schematic view of a second embodiment of an elemental hydrogen storage and retrieval system;

FIG. 4 is an elevational view of the surface of a porous silicon wafer having dendritic growth to increase surface area and facilitate hydrogen bonding thereto;

FIG. 5 is an elevational view of the surface of a porous silicon wafer that has been etched to create pits to increase surface area and facilitate hydrogen bonding thereto;

FIG. 6 is an isometric view, partially schematic, of an apparatus for centrifugally extruding silicon columns in accordance with the invention;

FIG. 7 is a cross-sectional view of a silicon column showing conformal deposition of additional silicon;

FIG. 8 is a cross-sectional view of a silicon column showing non-conformal deposition of additional silicon; and

FIG. 9 is an elevational view of an adsorptive silicon fiber mat comprising fibers formed in the apparatus shown in FIG. 6.

### DETAILED DESCRIPTION OF THE INVENTION

The exemplifications set out herein illustrate currently-preferred embodiments of the invention and are not to be construed as limiting the scope of the invention in any manner.

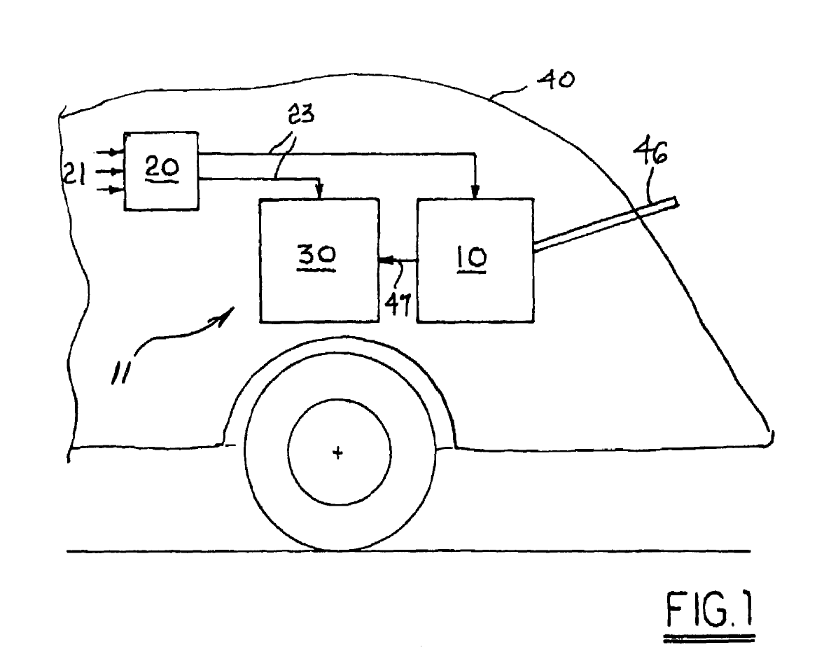

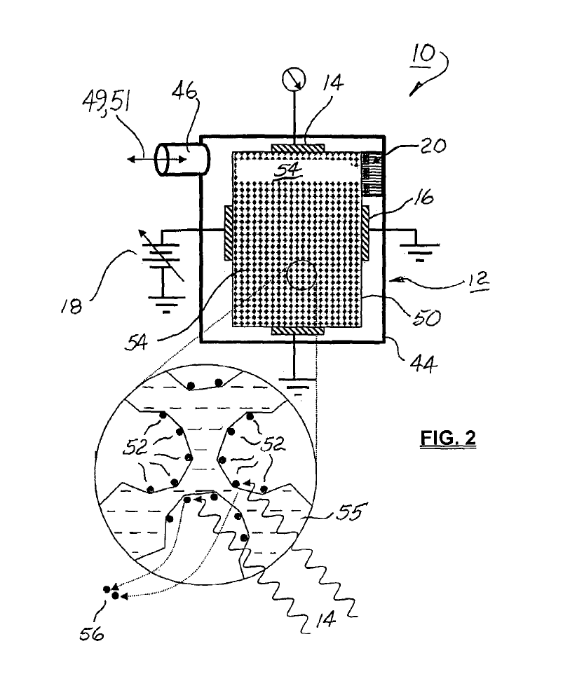

Referring now to FIGS. 1 and 2, there is shown one embodiment of a system 10 for the storage and retrieval of elemental hydrogen in accordance with the present invention. “Elemental hydrogen” as used herein means either the hydrogen dimer molecule H₂ or the individual hydrogen atom H having no net valence charge; and further, “hydrogen” refers to all isotopes having a single proton nucleus and atomic weights of one (hydrogen), two (deuterium), or three (tritium). It is believed that hydrogen as stored on a silicon surface is stored as individual atoms rather than in dimer form; however, the present invention is not bound by this belief. Further, the present invention is not restricted to storage of tritium, as in the prior art cited above.

Elemental hydrogen storage and retrieval system 10 includes hydrogen storage unit 12, light source 14, current source 16, voltage source 18, and control system 20.

Generally, elemental hydrogen storage and retrieval system 10 is used to store fuel for and provide fuel to a hydrogen-based fuel cell system 30, such as, for example, a solid oxide fuel cell system or a proton exchange membrane fuel cell system. In turn, hydrogen-based fuel cell system 30 provides electrical power to virtually any apparatus requiring electrical power to operate, for example, the electrical accessories and/or electrical motors of motor vehicle 40. The combination of hydrogen storage and retrieval system 10, control system 20, and fuel cell system 30 defines an Auxiliary Power Unit (APU) 11 for generating electricity from hydrogen and oxygen. It should be understood that an APU 11 in accordance with the present invention can be alternately configured, for example, with elemental hydrogen storage and retrieval system 10 and fuel cell system 30 being stationary, in order to power one or more electrical appliances within, for example, a house or business.

Hydrogen storage unit 12 includes a housing 44 having an inlet/outlet passage 46. Of course, separate inlet 46 and outlet 47 passages may be provided as desired, as shown in FIG. 1, to facilitate refueling, for example, of storage system 10. Housing 44 is constructed of one or more of a variety of materials, such as, for example, relatively light-weight plastic, aluminum, alloys, or steel, dependent primarily upon the environmental and other requirements of the particular application for which APU 11 is intended. The particular size of housing 44 is also dependent primarily upon the requirements, such as the required power, of the particular application for which hydrogen storage and retrieval system 10 is intended. This flexibility in the materials and size of housing 44 is afforded due to the ability of the present invention to safely retain elemental hydrogen even upon catastrophic failure of housing 44.

A plurality (only one shown) of hydrogen storage members 50 are disposed within housing 44. Generally, hydrogen storage members 50 adsorb elemental hydrogen atoms and selectively desorb, or release, previously adsorbed hydrogen atoms 52 which reform hydrogen molecules, H₂, and are recovered as gaseous hydrogen for fuel. As will be described more particularly hereinafter, hydrogen storage members 50 are constructed at least in part of a silicon material 54, preferably a porous silicon material 55, to which elemental hydrogen will readily bond or adsorb, such as, for example, a) single-crystal silicon wafers, or b) extruded polycrystalline silicon columns, fibers, or rods, or c) milled or crushed polycrystalline silicon particles, or d) combinations thereof, that have been processed to have an increased surface area and/or porosity and from which elemental hydrogen is selectively and relatively easily desorbed/released or retrieved in response to an applied stimulus source 14, 16, 18.

Various sources of stimulus and/or energy can be applied to break the bonds between the adsorbed hydrogen atoms 52 and the hydrogen storage members 50. The embodiment of hydrogen storage and retrieval system 10, as illustrated in FIG. 2, includes three different types of such energy sources, i.e., light source 14, current source 16, and voltage source 18.

In operation, light source 14, such as, for example, a light-emitting diode, emits photon energy and is disposed internal or external to housing 44 whereby the emitted photon energy can interact with the plurality of hydrogen storage elements 50 within housing 44. Light source 14 emits sufficient photonic energy to liberate or dislodge adsorbed hydrogen atoms 52 from their bonds to hydrogen storage members 50. Light source 14 is electrically interconnected with and controlled by control system 20 to direct a desired amount of photonic energy onto and thereby liberate a desired quantity of adsorbed hydrogen atoms 52 from hydrogen storage members 50. The liberated hydrogen atoms 56, in turn, form a flow of hydrogen molecules H₂ that is directed from hydrogen storage unit 12 into hydrogen-based fuel cell system 30. Fuel cell system 30 receives the flow of hydrogen molecules and converts in a known manner the hydrogen contained therein to a desired amount of electrical power.

Similarly, current source 16, such as, for example, a Joule heat source that generates heat by passing a current through the silicon matrix of hydrogen storage members 50, is disposed internal or external to housing 44. Current source 16 emits sufficient energy to desorb or liberate adsorbed hydrogen atoms 52 from their bonds to hydrogen storage members 50. Current source 16 is also electrically interconnected with and controlled by control system 20 to control the amount of current being directed through each of the plurality of storage members 50, and thereby liberate a desired quantity of adsorbed hydrogen atoms 52 from hydrogen storage members 50. The liberated hydrogen atoms 56, in turn, form a flow of hydrogen molecules H₂ that is directed out of hydrogen storage unit 12 and into hydrogen-based fuel cell system 30. Fuel cell system 30 receives the flow of hydrogen molecules and converts in a known manner the hydrogen contained therein to a desired amount of electrical power.

Still similarly, voltage source 18, such as, for example, a battery, is disposed internal or external to housing 44. Voltage source 18 creates a sufficiently intense electric field to desorb or liberate adsorbed hydrogen atoms 52 from their bonds to hydrogen storage members 50. Voltage source 18 is also electrically interconnected with and controlled by control system 20 to control the amount of voltage being applied to each of the plurality of storage members 50, which in turn controls the quantity of adsorbed hydrogen atoms 52 that are liberated from hydrogen storage members 50. The liberated hydrogen atoms 56, in turn, form a flow of hydrogen molecules H₂ that is directed out of hydrogen storage unit 12 and into hydrogen-based fuel cell system 30. Fuel cell system 30 receives the flow of hydrogen molecules and converts in a known manner the hydrogen contained therein to a desired amount of electrical power.

Control unit 20, such as, for example, a conventional microcomputer or microprocessor, receives a plurality of inputs 21 which are indicative of the amount of output power desired from fuel cell system 30 and various other operating parameters, such as, for example, ambient temperature. Control unit 20 also issues a plurality of outputs 23, including outputs that control at least in part the operation and output levels of light source 14, heat source 16, and/or voltage source 18. Control unit 20 also includes and executes operating and control software enabling it to control the operation of elemental hydrogen storage and retrieval system 10 and, optionally, fuel cell system 30.

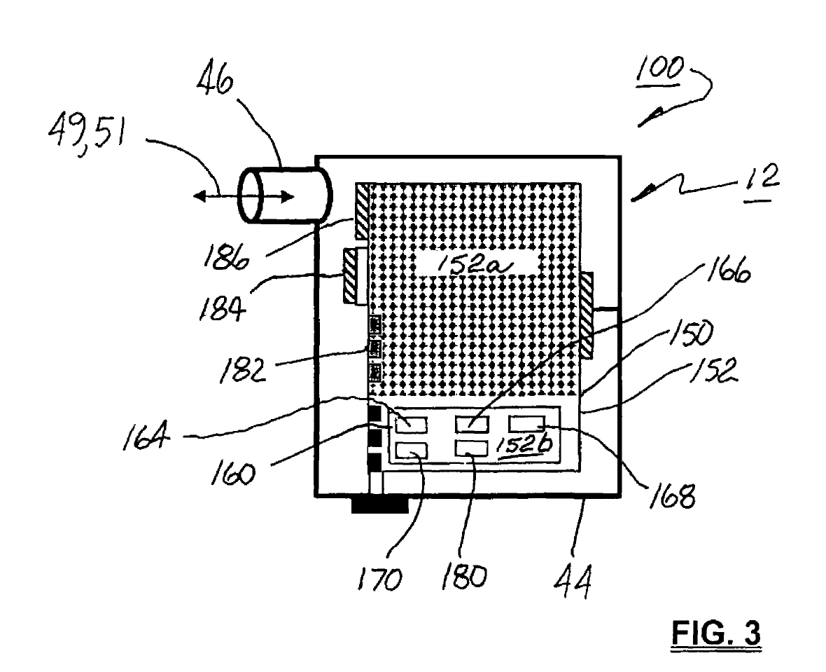

Referring now to FIG. 3, there is shown a second embodiment 100 of a system for the storage and retrieval of elemental hydrogen of the present invention. Elemental hydrogen storage and retrieval system 100 includes several component parts that are the same as or similar to the component parts of elemental hydrogen storage and retrieval system 10, and corresponding reference numbers are used to indicate corresponding parts. Elemental hydrogen storage and retrieval system 100 includes hydrogen storage unit 12, housing 44 having inlet/outlet 46, and hydrogen storage members 150. Generally, elemental hydrogen storage and retrieval system 100 integrates the desorption energy sources and the control electronics directly onto hydrogen storage members 150, as follows.

A plurality (only one shown) of hydrogen storage members 150 are disposed within housing 44. Hydrogen storage members 150 are constructed at least in part of single-crystal silicon wafers 152 (only one shown). Thus, hydrogen storage members 150 and hydrogen storage members 50 are substantially similar to each other in regard to the method by which they adsorb and desorb hydrogen atoms 52. However, and in general, single-crystal silicon wafers 152 are selectively processed over their surface areas a) to increase the porosity of a first portion 152a thereof, and b) to fabricate electronic components and circuitry on a second portion 152b thereof.

More particularly, portion 152a of single-crystal silicon wafer 152 is processed, as is described more particularly hereinafter, to increase the surface area and/or porosity thereof, such that elemental hydrogen will readily bond and/or adsorb onto, and be selectively and relatively-easily desorbed from, portion 152a of hydrogen storage member 150. Second portion 152b of hydrogen storage member 150 is not processed in order to increase the porosity thereof, as is portion 152a; rather, second portion 152b is processed according to conventional IC processing techniques to form thereupon integrated control and diagnostic circuitry, including, for example, transistors 164, resistors 166, capacitors 168, memory cells or arrays 170, and sensors 180.

Thus, hydrogen storage member 150 integrates onto a monocrystalline silicon wafer 152 the hydrogen storage function and various first-level control and diagnostic functions. By forming memory cells/arrays 170 onto second portion 152b, a history of the amount of hydrogen adsorbed and desorbed may be stored directly on hydrogen storage member 150. Diagnostic functions may also be performed through the execution by hydrogen storage member 150 of control and monitoring algorithms stored within memory cells/arrays 170, especially in coordination with control system 20. Such algorithms can monitor various operating parameters, such as, for example, bulk resistance, diode luminosity, surface condition, etc., by reading sensors 180. Thus, a user can be alerted as to how much power remains in the hydrogen storage members 150 powering fuel cell system 30, and whether any one or more of hydrogen storage members 150 requires service or repair.

It should be particularly noted that the structures required for the emission of photonic energy are integrated into section second portion 152a of hydrogen storage member 150 using conventional integrated circuit fabrication processes. More particularly, light-emitting diodes 182 configured for emitting photonic energy of a desired wavelength may be fabricated directly in the porous silicon of portion 152a according to known methods. One such method for forming light-emitting diodes in porous silicon is disclosed in U.S. Pat. Nos. 5,272,355 (Namavar, et al.) and 5,285,078 (Mimura, et al), the disclosures of which are incorporated herein by reference.

It should further be particularly noted that the structures required for the Joule heating and electric field generation may also be integrated into silicon wafer 152 of hydrogen storage member 150 through the use of conventional processes and structures for forming integrated circuits on silicon wafers. For example, Joule heating may be accomplished by passing an electrical current through one or more electrodes or traces 184 fabricated upon silicon wafer 152 so that heat is passed through either portion 152a or portion 152b, to affect desorption. Electric field creation can be accomplished by fabricating spaced-apart electrodes or traces 186 upon silicon wafer 152 of hydrogen storage member 150, and applying a potential or voltage difference between the electrodes to thereby create an electric field, to affect desorption.

As disclosed above, hydrogen storage members 50 and 150 are formed of a material to which elemental hydrogen will readily bond, such as, for example, a block or wafers of monocrystalline silicon that have been processed to have an increased surface area and/or porosity, and from which elemental hydrogen is selectively and relatively easily desorbed/released or retrieved in response to an applied stimulus. The methods by which hydrogen storage members 50 and 150 may be processed are now discussed.

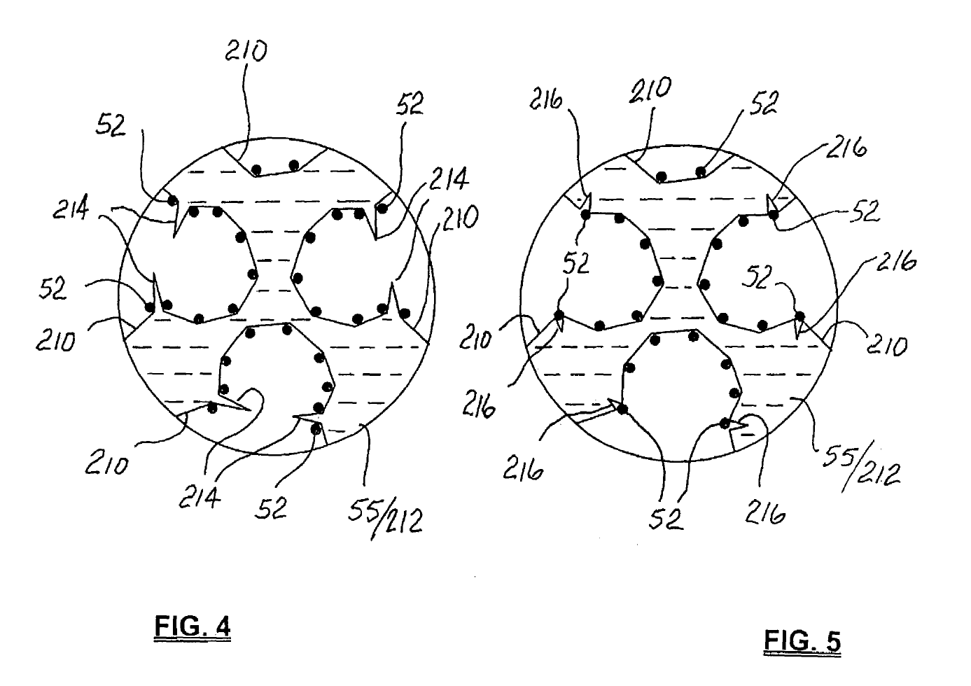

Methods of forming silicon into a crystalline matrix having semiconductive properties are well known and need not be discussed herein. Also well-known are methods of selectively forming regions of porous silicon in a semiconductive crystalline matrix. For example, applying a mixture of even parts of hydrofluoric acid and methanol to a crystalline silicon matrix at a current density of 50 milliAmps (mA) per square centimeter (cm²) renders single-crystal silicon porous, as is more fully described in “Infrared Free Carrier Absorption in Mesoporous Silicon,” Rapid Research Notes, Phys. Stat. Sol, (b) 222, R1 (2000) by V. Yu Timoshenko, Th. Dittrich, and F. Kock, which is incorporated herein by reference. Applying these conditions for a period of approximately 30 minutes creates a layer of porous silicon approximately 75 micrometers (μm) thick having a porosity of approximately 50%. The remaining nanocrystals, shown as 55/212 in FIGS. 4 and 5, are approximately 5 to 10 nm in extent, and represent interconnected islands of single-crystal silicon within a voided space. This layer of porous silicon has a substantially reduced gross density and a surface area that is substantially increased over that of the crystalline silicon prior to such processing.

Yet another method of selectively forming regions of porous silicon in a semiconductive crystalline matrix is taught in U.S. Pat. No. 6,407,441 (Yuan), which is incorporated herein by reference.

The porous silicon layer formed by one of the methods described above, or other methods now known or later devised, exposes one or more of the four valence bonds on the outer ring of the silicon atoms within the crystalline structure. This exposed valence bond is highly active and will readily accept a hydrogen atom. Since this exposed valence bond will also readily bond to other atoms, such as, for example, oxygen, the etched/porous silicon must be isolated from such other reactive elements and exposed only to hydrogen atoms or hydrogen gas upon completion of the etching process. Thus, until the etched and porous silicon is exposed to the hydrogen gas, the silicon surfaces may be exposed only to inert gases, for example, argon and helium. Thus, during processing the silicon must be contained or enclosed within a controlled environment that precludes exposure to other than inert and/or hydrogen gases.

Porous silicon strikes a favorable balance between having a high surface area and maintaining an open matrix that allows hydrogen gas to diffuse into and out of the matrix. Once the porous silicon has been formed, additional steps can be used to further increase the surface area thereof still further. For example, the porosity etch can be followed with an anisotropic silicon etchant, such as, for example, potassium hydroxide or hydrazine, to expose crystal planes on the silicon nanocrystals. These crystal planes have a high density of dangling bonds, which readily accept termination by an element of hydrogen. Another method by which the surface area of porous silicon can be increased is to roughen the interior surfaces thereof. This can be done through dendritic growth or through etching.

More particularly, as shown in FIGS. 4 and 5, dendritic growth on the inside surfaces 210 of the porous silicon 55/212 creates silicon spikes 214 to which hydrogen atoms can bond, and etching the surfaces 210 of the porous silicon 55/212 creates pits 216 within or adjacent to which additional hydrogen atoms 52 can bond.

The silicon activation energies, i.e., the adsorption and desorption energies of hydrogen on silicon, must also be controlled. This is accomplished through one or more techniques comprising chemical activation, temperature activation, application of electric fields, and photon energy.

Chemical activation may include the electrodeposition of a catalyst, for example, palladium or platinum, onto the silicon surface to facilitate the bonding process. Certain gases, for example, hydrogen chloride, can cleanse the silicon surface, as is well known in the art of integrated circuit fabrication, although such gases are not, in the prior art, applied to porous silicon to increase the adsorption of hydrogen by the silicon.

Controlling ambient temperature or the temperature of hydrogen storage members 50 and 150 also affects the activation energies, which follow an Arrhenius law and are thus generally exponential dependent upon temperature. Raising the temperature of the porous silicon of hydrogen storage members 50 and 150 increases the thermal energy of the adsorbed hydrogen therein and tends to cause desorption of the hydrogen which then moves as a gas through the voids in the silicon. Conversely, cooling the porous silicon of hydrogen storage members 50 and 150 reduces the thermal energy of the adsorbed hydrogen and tends to reduce desorption.

The application of an electric field across the porous silicon of hydrogen storage members 50 and 150 also affects the activation energies. By applying a large electric field across the porous silicon, desorption is promoted.

Similarly, photonic energy can be applied to promote desorption. Silicon is relatively transparent to radiation at infra-red wavelengths above approximately 700 nanometers (nm). The hydrogen atom has a very strong absorption peak at approximately 660 nanometers, which falls within the range of silicon transparency. Thus, the desorption rate of hydrogen stored within or bonded to the silicon of hydrogen storage members 50 and 150 may be affected through the application of photonic energy at certain wavelengths and intensities. Light source 14 and/or light-emitting diodes 182 are preferably configured as emitting light or photonic energy having a wavelength of approximately 660 nm, for absorption by the hydrogen atoms to promote desorption of the hydrogen from the silicon surfaces.

Controlling the adsorption and desorption energies through one or more of the methods described above enables elemental hydrogen storage and retrieval system 10 to be adapted to a variety of specific applications. For example, in applications wherein safety is a primary consideration, such as, for example, a motor vehicle, high adsorption energies may be selected to more strongly bind the hydrogen atoms to the silicon within hydrogen storage members 50 and 150. At high adsorption energies, the hydrogen atoms can remain tightly bound to the silicon of hydrogen storage members 50 and 150 even upon a catastrophic equipment failure, such as, for example, a breach of housing 44 and/or shattering of hydrogen storage members 50 and/or 150 themselves in a vehicle collision. However, higher adsorption energies require higher desorption energies to retrieve the hydrogen fuel. Thus, a combination of Joule heating, application of electric fields, and/or light may be required to facilitate rapid retrieval in normal operation.

It should be particularly noted that the crystalline silicon which is processed as described above to produce the porous silicon typically may be doped or impregnated with one or more other elements, commonly boron, which renders the silicon highly conductive and thereby facilitates the formation of porous silicon. However, if photon energy is to be applied to achieve or facilitate desorption, further processing of the silicon, such as, for example, a counter-doping with phosphorous or arsenic may be required to maintain transparency of the porous silicon to infra-red light.

In embodiments 10,100, three different types of desorption energy sources are shown, i.e., light source 14, heat source 16 and voltage source 18. However, it should be understood that hydrogen storage and retrieval system 10,100 can be alternately configured, for example, with only one or two, or with various configurations of, the energy sources shown and/or with other types of energy sources suitable for applying a sufficient energy in a controlled manner for breaking the bonds between the adsorbed elemental hydrogen and hydrogen storage members 50.

In the embodiment shown, hydrogen storage members 50 and 150 are fabricated from silicon wafers. However, it is to be understood that hydrogen storage members 50 and 150 can be formed from alternate materials, such as, for example, germanium, gallium arsenide, indium antimonide, or other periodic table III-V or II-VI compounds.

Alternatively, storage members 50,150 may be formed of mats 59 of fine columns or threads of silicon, as shown in FIG. 9. Silicon columns may be formed having very high surface/volume ratios. Referring to FIG. 6, an apparatus 200 for generating silicon columns 202 is shown. Apparatus 200 is a centrifugal extruder comprising a reservoir 204 for molten silicon 206, the reservoir having side walls 208, and a driven shaft 220 for rotating the reservoir at high speed. Side walls 208 are provided with a plurality of fine apertures 222 through which molten silicon is centrifugally extruded as continuous columns 202. Extrusion may be assisted by pressure or gravity, and may even be carried out without use of centrifugal force.

To generate suitable silicon columns, first, the size of each aperture 222 must be very small. To achieve storage efficiency on the order of 10%, as measured by the weight of hydrogen stored per unit weight of silicon matrix, the feature size of the silicon should be on the order of 10 Angstroms, or 1 nanometer. It is a key feature of the invention that aperture 222 be an integral multiple of the lattice spacing of silicon. In this way, the silicon column extruded will have a minimum energy configuration suitable for forming a crystal. The shape should also be suitable for the desired crystallography, as discussed further below.

Second, the aperture should be operated under centrifugal force, which helps to drawout the silicon, thereby overcoming surface tension effects. With insufficient centrifugal force, the silicon may tend to form spherical beads. It is preferred that the extruded silicon be a column of polycrystalline material. These columns may be long whiskers, or they may break off in relatively short pieces, depending upon process parameters. An aspect ratio of length to diameter greater than 10 is preferred.

Third, the environment 224 into which the extruded silicon emerges should be an inert gas, such as helium, argon, neon, or hydrogen itself. With a hydrogen ambient atmosphere, the task of activating the surface with adsorbed hydrogen atoms will already be partially accomplished. It is especially important that the ambient gas not be oxygen or nitrogen, both of which react chemically and irreversibly with hot silicon.

Fourth, the aperture material, shape (including internal channels), and surface treatment should be sufficient to provide a low Reynolds number so that crystalline order is preferentially formed in the extrusion, and so that long whiskers of silicon are created. The apertures must be formed of a very durable material, for example, tungsten aluminide, aluminum oxide (or sapphire Al₂O₃), diamond-like carbon (DLC), or silicon carbide. For convenience, these materials may also be used as a surface coating on an otherwise easy-to-fabricate structural material such as graphite or refractory ceramic.

Fifth, the number of apertures 222 in apparatus 200 should be very high, so that high throughput can be realized. A high density of holes may be achieved through a wide variety of methods known to those skilled in the art, for example, electron beam etching, conventional photolithography, micromachining, molding using the lost-wax technique, stamping, and/or etching.

The (111) plane of a silicon crystal has the highest density of unsatisfied (dangling) bonds per given surface area. Therefore, the shape and dimension of an aperture may be selected to favor formation of crystalline columns of extruded silicon with surfaces on the (111) plane. An aperture in the shape of a triangle or rhombus is preferred, although other shapes such as a square or circle may be easier to fabricate and to keep clean, and are fully comprehended by the invention. A square aperture will tend to favor (100) silicon, which may not be optimal for hydrogen storage, although subsequent surface treatments can make this a suitable choice.

Alternatively, storage members 50 may be formed of finely-divided polycrystalline silicon particles that may be formed by grinding, crushing, and/or milling of billets or ingots of polycrystalline silicon.

Alternatively, waste material from cutting, grinding, and polishing steps in the manufacture of integrated circuits, when sufficiently comminuted, is especially well suited as a hydrogen storage member 50,150. For silicon recovered from a waste stream, in general there will be no crystallinity, or it may exist on only a small order. Waste stream silicon should be made as fine as possible so as to expose as much surface area as possible. Preferably, to achieve storage capacity on the order of 10% (weight of hydrogen to weight of silicon matrix), the feature size of the silicon should be on the order of 10 Angstroms, or 1 nanometer, as in the silicon columns 202 discussed above. Waste stream silicon will almost always require surface treatments to obtain a clean surface for hydrogen adsorption.

In addition, surface roughening of either extruded columns or waste stream silicon is preferred to greatly increase the surface area and thus the hydrogen storing capacity of the silicon. Surface roughening can be accomplished, for example, by additive or subtractive methods. Subtractive methods may include etching, as discussed above, which is selective to crystal orientation, or is by nature highly anisotropic. Wet etches to delineate crystal plates, and perhaps expose (111) planes on polycrystalline material, are well known to those skilled in the art and can be applied to advantage in the invention. Defect decoration etches, such as those which delineate polysilicon grain boundaries, can apply well to short-order crystalline structures. Dry etching can provide additional advantages in surface roughening, either through known principles of reactive ion etching within a DC electric field or by selecting the etch chemistry to create “grass” from micromasking by etch by-products. These techniques for increasing surface area can be applied to a collected assortment of small pieces of silicon which does not need to be in a wafer format.

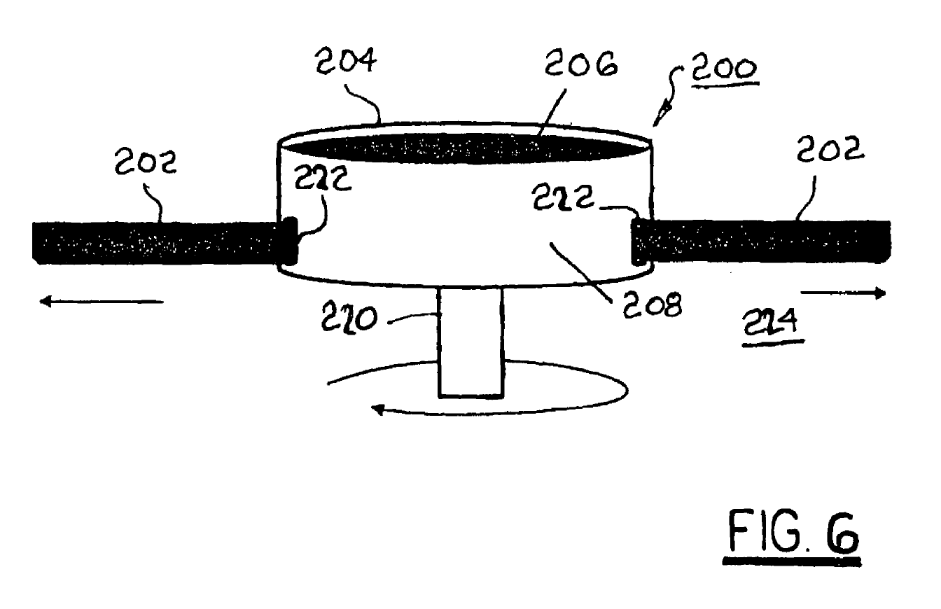

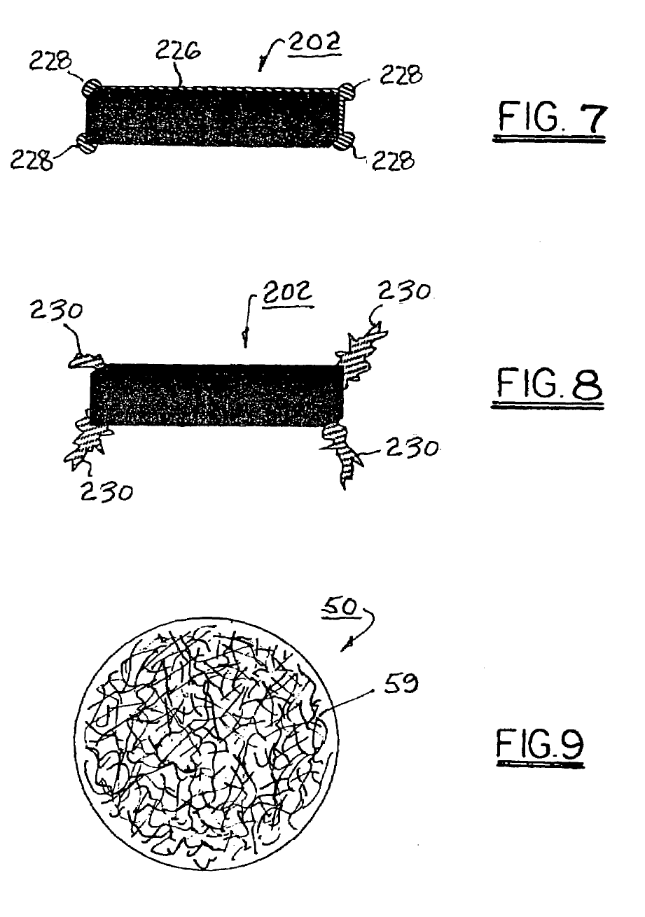

A second approach to surface roughening is additive deposition of silicon. Silicon can be deposited in known fashion via chemical vapor deposition (CVD), wherein silicon-bearing gas molecules react on hot surfaces (typically 500° C.-1250° C.) to leave behind elemental silicon. Deposition can be carried out at lower temperatures and at generally higher rates through addition of a plasma, which helps the silicon-bearing molecule to dissociate. This so-called plasma-enhanced CVD (PE-CVD) can be accomplished at temperatures below 200° C. A key feature of PE-CVD is that the deposition properties can be modified to adjust the degree of conformality of the deposited film. While a perfectly conformal film is generally desirable for IC manufacture, for this invention a substantial degree of non-conformality is an advantage. Non-conformal deposition, especially of very thin films, tends to concentrate on sharp edges and exposed surfaces, making it possible to increase the surface/volume ratio of the silicon substrate under suitable conditions. FIG. 7 shows a representative view of a non-conformal growth 226 applied to an extruded column 202 of silicon, shown in cross-section. The key features to note are the “mouse ears” 228 on the corners.

Additive silicon also can be created through use of electroplating. By applying well-known principles of electroplating, silicon atoms can be added to a silicon substrate with suitable electrical contact in a suitable bath containing dissolved silicon ions. Under some deposition conditions, electroplating is known to cause dendritic growth on silicon, especially when the bath is near super-saturation. Dendritic growth can create structures with very high surface/volume ratios, making it an excellent choice for improving hydrogen storage media. FIG. 8 shows a possible outcome of intentional dendritic growth 230 at the corners of column 202 through electroplating.

Surface activation energies are of critical importance to the present invention. Of prime importance is a clean silicon surface. As disclosed above, forming the silicon in an inert atmosphere is important to prevent unwanted oxidation of the silicon. It may be expected that any environment will provide some amount of surface contamination, and the dangling bonds of the bare silicon surfaces will form favorable collection sites for many chemical species; it is this property, of course, that makes silicon an excellent choice for hydrogen storage medium. However, if those sites are already occupied or blocked by other species, the storage capacity for hydrogen will be low. Many methods are known for cleaning silicon surfaces, such as the well-known RCA clean followed by a dip in 30:1 hydrofluoric acid. The RCA clean removes organics with acid and inorganics with base. Other known methods involve cleaning with a series of volatile solvents, such as xylene, acetone, or trichloroethylene. Solvent cleaning may be followed by an alcohol and DI water rinse. Vapor cleaning, plasma cleaning, abrasive cleaning, vacuum evaporative heating, and many other known methods are well-known for making clean surfaces on silicon. Any of these methods may be adapted for use in accordance with the invention.

In addition to surface cleaning, further preparations may be made to enhance the activation energy of the silicon, such as deposition of a catalyst material, treatment with hydrogen chloride gas, or the addition of certain chemical compounds. When assembling the final system, potential storage capacity may need to be traded off with factors such as desorption rates and activation temperatures, so maximizing storage capacity may not prove to be the optimum configuration in all cases.

A key feature of a hydrogen storage system in accordance with the invention is flexibility in packaging of the silicon to be used for hydrogen storage. Extruded columns 202, drawn through a large number of small apertures, tend to form a mesh 59 or wool of silicon, as shown in FIG. 9. The porosity of the mesh can be modified by additive methods of adding silicon to the extruded columns, or by the addition of a certain fraction of reclaimed silicon, which may be in the form of irregular clusters. The resulting mesh 59 is vapor-permeable, such that hydrogen can flow freely through it. Because of this ease of flow, the storage container for the silicon may assume a wide variety of shapes, sizes, and aspect ratios. For example, in vehicle applications, an advantage of the present invention is that hydrogen storage may be distributed in “unused” spaces throughout the vehicle instead of requiring single point storage such as a prior art gasoline tank. Thus, hydrogen may conveniently be stored within floors, fenders, quarter panels, rocker panels, doors, columns, posts, trunk, roof, and combinations thereof.

For miniaturized applications, a more rigorous packing of silicon may be desired. For example, using non-conformal deposition as described hereinabove to create “mouse ears” 228 on the corners of extruded silicon columns 202 can prevent the columns from close-packing, thereby preserving free flow of hydrogen as well as high silicon packing density.

For very large applications, such as space vehicles or home power generation, the present method for creating low-cost silicon for hydrogen storage brings economies of scale, making hydrogen storage financially attractive. Large vats of treated silicon can be formed with little concern for the arrangement of the material. Using suitable choices for additive growth, or a mix of irregular clusters and extruded columns, the present invention allows a wide range of tradeoffs between package density and hydrogen delivery rate.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

1. An auxiliary power unit for generating electrical power, the auxiliary power unit comprising:
a fuel cell system operable to combine hydrogen and oxygen to generate electrical power; and
a system for storing and retrieving elemental hydrogen that is then supplied as hydrogen gas to the fuel cell system, the storing and retrieving system comprising a hydrogen storage member and a control system, the hydrogen storage member comprising porous silicon having interior and exterior surfaces, at least the interior surfaces having dangling bond sites at which reversible chemisorption of hydrogen atoms occurs, the control system being operable to liberate the chemisorbed hydrogen atoms from the dangling bond sites and release the liberated hydrogen atoms as hydrogen gas for use by the fuel cell system.

2. The auxiliary power unit in accordance with claim 1, wherein the porous silicon is a porous silicon mass.

3. The auxiliary power unit in accordance with claim 1, wherein the porous silicon is a porous mesh of silicon columns.

4. The auxiliary power unit in accordance with claim 1, wherein the fuel cell system is selected from the group consisting of solid oxide fuel cell system and proton exchange membrane system.

5. The auxiliary power unit in accordance with claim 1, wherein the auxiliary power system is installed in a vehicle.

6. The auxiliary power unit in accordance with claim 5, wherein the vehicle comprises a plurality of hydrogen storage members each in accordance with claim 1, and the hydrogen storage members are located at multiple different locations within the vehicle.

7. The auxiliary power unit in accordance with claim 6, wherein the locations are one or more selected from the group consisting of floors, fenders, quarter panels, rocker panels, doors, columns, posts, trunk, and roof of the vehicle.

8. The auxiliary power unit in accordance with claim 1, further comprising releasing means controlled by the control system for causing the chemisorbed hydrogen atoms to be liberated from the dangling bond sites.

9. The auxiliary power unit in accordance with claim 8, wherein the releasing means is selected from the group consisting of light sources, current sources, voltage sources, and combinations thereof.

10. The auxiliary power unit in accordance with claim 8, wherein the releasing means comprises a light-emitting diode.

11. The auxiliary power unit in accordance with claim 8, wherein the releasing means comprises a light source that emits photon energy at a wavelength of about 660 nanometers.
